(19) United States
(12) Patent Application Publication
(10) Pub. No.: US 2024/0259777 A1
(43) Pub. Date: Aug. 1, 2024

(54) FEATURE ALLOCATION BETWEEN A ROAMING AP MLD AND AFFILIATED AP MLDS

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/427,238

(22) Filed: Jan. 30, 2024

Related U.S. Application Data
(60) Provisional application No. 63/482,552, filed on Jan. 31, 2023.

(51) Int. Cl. H04W 8/12; H04W 4/90; H04W 52/02; H04W 80/02

(52) U.S. Cl. CPC H04W 8/12; H04W 4/90; H04W 52/0216; H04W 80/02

(57) ABSTRACT

One example discloses a protocol for wireless communication feature allocation, including: wherein the protocol is configured to, allocate a first set of features to a roaming AP (access point) MLD (multi-link device); and allocate a second set of features to a set of AP MLDs affiliated with the roaming AP MLD.

### REFERENCE TO PROVISIONAL APPLICATION TO CLAIM PRIORITY

A priority date for this present U.S. patent application has been established by prior U.S. Provisional Patent Application Ser. No. 63/482,552, entitled “Roam AP MLD: features in roaming AP MLD vs in AP MLD level”, filed on Jan. 31, 2023, and commonly assigned to NXP USA, Inc.

The present specification relates to systems, methods, apparatuses, devices, articles of manufacture and instructions for wireless communications feature allocation.

### SUMMARY

According to an example embodiment, a protocol for wireless communication feature allocation, comprising: wherein the protocol is configured to, allocate a first set of features to a roaming AP (access point) MLD (multi-link device); and allocate a second set of features to a set of AP MLDs affiliated with the roaming AP MLD.

In another example embodiment, the set of features includes Traffic Identifier (TID) to Link mapping.

In another example embodiment, all of the set of AP MLDs of the roaming AP MLD announces a same TID-to-Link mapping negotiation support level.

In another example embodiment, at least one of the set of AP MLDs of the roaming AP MLD announce a different TID-to-Link mapping negotiation support level.

In another example embodiment, the roaming AP MLD announces a TID-to-Link mapping.

In another example embodiment, a non-AP MLD has multiple sets of setup links with the set of AP MLDs.

In another example embodiment, the roaming AP MLD and the non-AP MLD negotiate which TID is mapped to each of the set of AP MLDs.

In another example embodiment, the non-AP MLD negotiates with each of the set of AP MLDs which TID is mapped to each of the set of AP MLDs.

In another example embodiment, TID-to-Link mapping that is negotiated using individually addressed frames during a roaming procedure may override TID-to-Link mapping announced by at least one of the set of AP MLDs affiliated with the roaming AP MLD.

In another example embodiment, a non-AP MLD has one set of setup links with one of the set of AP MLDs.

In another example embodiment, the non-AP MLD negotiates with the one of the set of AP MLDs the TID-to-link mapping.

In another example embodiment, the non-AP MLD may follow a TID-to-Link mapping announced by an associated AP MLD in addition to a negotiated TID-to-Link mapping.

In another example embodiment, the set of features includes a Block Acknowledgement (BA) agreement, the BA agreement is a roaming MLD level feature, and the BA negotiation is done between a non-AP MLD and the roaming AP MLD.

In another example embodiment, the set of AP MLDs all announce a same feature agreement.

In another example embodiment, a feature agreement negotiation is done between a non-AP MLD and the roaming AP MLD.

In another example embodiment, a feature agreement negotiation is done between a non-AP MLD and a current serving AP MLD.

In another example embodiment, a feature agreement negotiation is done between a non-AP MLD and a new serving AP MLD.

In another example embodiment, the set of features includes at least one of: a stream classification service (SCS), Emergency Preparedness Communications Service (EPCS) agreement, link recommendation, and EML (Enhanced Multi-Link) Operation; and the at least one of the set of features is a roaming AP MLD level feature.

In another example embodiment, the set of features includes at least one of: a stream classification service (SCS), Emergency Preparedness Communications Service (EPCS) agreement, link recommendation, AP MLD recommendation, security, and EML (Enhanced Multi-Link) Operation; and the at least one of the set of features is an AP MLD level feature.

In another example embodiment, the set of features includes a channel switch announcement; and a first one of the set of AP MLDs announces a channel switch before completing the channel switch, and another one of the set of AP MLDs announces the first one of the set of AP MLDs channel switch also before the channel switch is completed.

In another example embodiment, adding or removing of a link of at least one of the set of AP MLDs is announced by other links of the at least one of the set of AP MLDs.

In another example embodiment, adding or removing of a link of at least one of the set of AP MLDs is announced by another one of the set of AP MLDs when the at least one and the another one of the set of AP MLDs are neighboring AP MLDs.

In another example embodiment, adding or removing of a link of at least one of the set of AP MLDs is announced as a reconfiguration at the roaming AP MLD level.

In another example embodiment, at least one of the set of AP MLDs are configured to allocate at least one of the second set of features to a physical link level of the at least one AP MLD with a non-AP device.

In another example embodiment, the features include medium access control (MAC) features; the roaming AP MLD has a MAC service access point (SAP) address; and the first AP MLD and the second AP MLD have a same MAC SAP address as the roaming AP MLD.

In another example embodiment, the set of AP MLDs includes a first AP MLD and a second AP MLD; a first set of links are established between a non-AP MLD and the first AP MLD when the non-AP MLD is at a first physical location; and a second set of links are established between the non-AP MLD and the second AP MLD when the non-AP MLD is at a second physical location.

In another example embodiment, the non-AP MLD is either a UHR non-AP MLD or an EHT non-AP MLD.

In another example embodiment, the set of features includes Target Wake Time (TWT).

According to an example embodiment, a method for feature allocation between a roaming AP MLD and a set of affiliated AP MLDs for wireless communications, comprising: allocating a first set of features to a roaming AP (access point) MLD (multi-link device); and allocating a second set of features to a set of AP MLDs affiliated with the roaming AP MLD.

The above discussion is not intended to represent every example embodiment or every implementation within the scope of the current or future Claim sets. The Figures and Detailed Description that follow also exemplify various example embodiments.

Various example embodiments may be more completely understood in consideration of the following Detailed Description in connection with the accompanying Drawings.

### BRIEF DESCRIPTION OF THE DRAWINGS

FIG. 1 represents a first example wireless local area network (WLAN) including an access point (AP) multi-link device (MLD) and a non-AP MLD (e.g. a client station (STA)).

FIG. 2 represents an example roaming operation for a roaming non-AP MLD 11 within a second example WLAN.

FIG. 3 represents an example of reporting and reported links supporting the roaming operation.

FIG. 4 represents an example protocol for feature allocation.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

### DETAILED DESCRIPTION

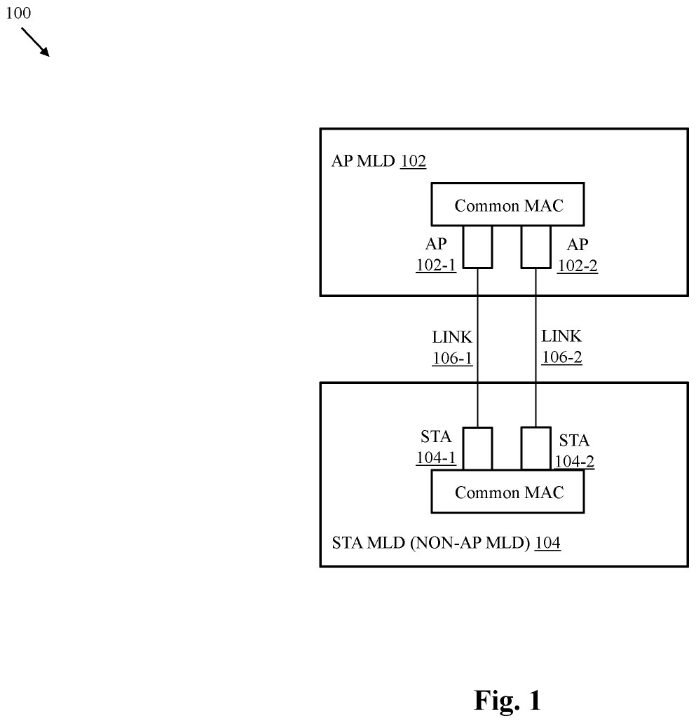

FIG. 1 represents an example wireless local area network (WLAN) 100 including an access point (AP) multi-link device (MLD) 102 and a non-AP MLD (e.g. a client station (STA)) 104. In some example embodiments, the WLAN 100 exchanges frames in accordance with an IEEE 802.11 protocol (e.g. 802.11be, 802.11ac very high throughput (VHT) protocol, 802.11ax high efficiency (HE) protocol, 802.11be extreme high throughput (EHT) protocol, 802.11bn ultra-high reliability (UHR) protocol, etc.).

In the example WLAN 100, the AP MLD 102 includes two access points (APs) 102-1 and 102-2. In some example embodiments, the AP MLD 102 implements upper layer Media Access Control (MAC) functionalities (e.g., association establishment, reordering of frames, etc.) and the APs 102-1 and 102-2 implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device.

In some example embodiments, the WLAN 100 is coupled to a backbone network (e.g., the Internet) through a wired connection and wirelessly connects to wireless STAs. In some example embodiments, an AP (e.g., AP1 102-1 and/or AP2 102-2) includes multiple RF chains. In some example embodiments, an AP (e.g., AP1 102-1 and/or AP2 102-2) includes at least one antenna, at least one transceiver operably connected to the at least one antenna, and at least one controller operably connected to the corresponding transceiver. In some example embodiments, at least one transceiver includes a physical layer (PHY) device. The at least one controller may be configured to control the at least one transceiver to process received packets through the at least one antenna.

In some example embodiments, the at least one controller may be implemented within a processor, such as a microcontroller, a host processor, a host, a digital signal processor (DSP), or a central processing unit (CPU), which can be integrated in a corresponding transceiver. In some example embodiments, each of the APs 102-1 and 102-2 of the AP MLD 102 with multiple RF chains may operate in different basic service set (BSS) operating channels (in different links). For example, AP1 102-1 may operate in a 320 MHz BSS operating channel at 6 GHz band, and AP2 102-2 may operate in a 160 MHz BSS operating channel at 5 GHz band.

The non-AP STA MLD 104 in this example WLAN 100 includes two non-AP STAs 104-1 and 104-2. The STAs 104-1 and 104-2 may be implemented in hardware (e.g., circuits), software, firmware, or a combination thereof. The STAs 104-1 and 104-2 may be fully or partially implemented as an IC device. In some example embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol.

In some example embodiments, the STA MLD 104 implements a common MAC functionality and the non-AP STAs 104-1 and 104-2 implement a lower layer MAC data functionality.

In some example embodiments, the AP MLD 102 and/or the STA MLD 104 may identify which communication links support multi-link operation during a multi-link operation setup phase and/or exchanges information regarding multi-link capabilities during the multi-link operation setup phase.

In some example embodiments, each of the non-AP STAs 104-1 and 104-2 of the STA MLD 104 may operate in different frequency bands. For example, the non-AP STA 104-1 in one link may operate in the 2.4 GHz frequency band and the non-AP STA 104-2 in another link may operate in the 5 GHz frequency band. In some example embodiments, each STA includes at least one antenna, at least one transceiver operably connected to the at least one antenna, and at least one controller connected to the corresponding transceiver. In some example embodiments, at least one transceiver includes a PHY device. The at least one controller may be configured to control the at least one transceiver to process received packets through the at least one antenna. In some example embodiments, the at least one controller may be implemented within a processor, such as a microcontroller, a host processor, a host, a DSP, or a CPU, which can be integrated in a corresponding transceiver.

In this example 100, the STA MLD 104 communicates with the AP MLD 102 via two communication links 106-1 and 106-2. The communication links (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD).

In some example embodiments, a 20 MHz channel may be a punctured 20 MHz channel or an unpunctured 20 MHz channel.

As described above a multi-link AP MLD has one or multiple links where each link has one AP affiliated with the AP MLD. This may be accomplished by having the different radios for the different affiliated APs. A multi-link STA MLD has one or multiple links where each link has one STA affiliated with the STA MLD. One way to implement the multi-link STA MLD is using two or more radios, where each radio is associated with a specific link. For example, a multi-link multi-radio (MLMR) non-AP MLD may be used. The MLMR non-AP MLD uses multiple full functional radios to monitor the medium in multiple links. Another way to implement the multi-link STA MLD is using a single radio in two different bands. Each band may be associated with a specific link. In this case, only one link is available at a time.

In yet another implementation, an enhanced single-radio (ESR) STA MLD may be used that operates in an enhanced multi-link single radio (eMLSR) mode. The ESR STA MLD uses two radios in different bands to implement the MLD. For example, one radio may be a lower cost radio with lesser capabilities and the other radio may be a fully functional radio supporting the latest protocols. The ESR STA MLD may dynamically switch its working link while it can only transmit or receive through one link at any time. The ESR STA MLD may monitor two links simultaneously, for example, detecting medium idle/busy status of each link, or receiving a PPDU on each link.

Each radio may have its own backoff procedure, and when the backoff counter for one of the radios becomes zero, that radio and link may be used for transmission. For example, if an AP wants to use the fully functional radio, it may send a control frame with the padding that is long enough for the ESR STA MLD to switch from the lesser capable radio to the fully functional radio that may then receive/transmit data to the AP.

When an extended service set (ESS) includes multiple AP MLDs in different locations and a STA MLD executed the data frame exchanges with one of the AP MLDs (e.g., AP MLD 1), as the STA MLD moves/roams to another location to do the data frame exchanges with another one of the affiliated AP MLDs (say AP MLD 2), the STA MLD (same as a non-AP MLD herein) needs to finish the association (e.g. handoff) with AP MLD 2 before doing the data frame exchanges with AP MLD 2. Such association with a new AP MLD introduces service interruption which needs the improvement.

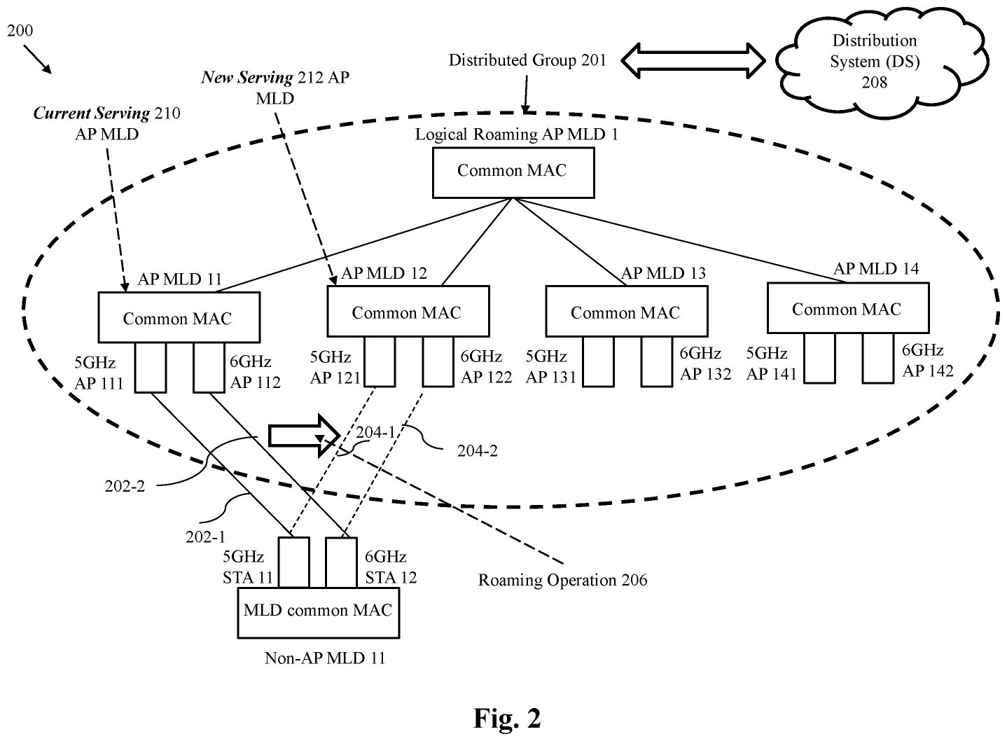

FIG. 2 represents an example roaming operation 206 for a non-AP MLD 11 that roams within a second example WLAN 200. A logical roaming AP MLD 1 includes a number of different affiliated AP MLDs 11, 12, 13, 14, some of which may be co-located, but many of which are in substantially different physical/geographic locations. Together they operate as a distribution group 201 (e.g. mobility domain) having a common MAC service access point (SAP) address (e.g. “Common MAC” shown in FIG. 2).

Note, the roaming AP MLD 1 is a logical MLD that itself is NOT actually “moving”, but is affiliated with the other MLDs 11, 12, 13, 14 which are typically at “different geographical locations”. Typically only the non-AP MLD 11 (e.g. a vehicle or person's smartphone) is “moving” between the “different geographical locations” but a hitless/seamless handoff experience is provided to the non-AP MLD 11 using the “Common MAC” address.

Seamless (i.e. hitless) roaming is a type of wireless roaming that allows a non-AP device (e.g. a mobile device) to switch between different AP devices without interrupting frame exchanges with the non-AP device. This means the non-AP device can maintain a continuous connection to a roaming AP MLD, a distribution system (DS), an ESS, a network, etc. while physically moving, without the need for additional association. In one embodiment, a non-AP MLD has one serving AP MLD for its frame exchanges when the non-AP MLD doesn't do the roaming or finishes it roaming. In another embodiment, a non-AP MLD can have multiple serving AP MLDs for its frame exchanges when the non-AP MLD doesn't do the roaming or finishes it roaming. For a non-AP MLD, the roaming AP may be a logical entity that exists in the current serving AP MLD of a non-AP MLD.

Each AP MLD 11, 12, 13, 14 has its own unique ID (identifier) in the distributed (e.g. logical roaming) AP MLD group 201. These unique IDs each have a different ID space. In another embodiment, each AP MLD in a roaming AP MLD is identified by its MAC SAP address, which means that the additional ID is not needed.

In this example 200, the AP MLD 11 includes 5 GHz AP 111 and 6 Ghz AP 112. The AP MLD 12 includes 5 GHz AP 121 and 6 Ghz AP 122. The AP MLD 13 includes 5 GHz AP 131 and 6 Ghz AP 132. The AP MLD 14 includes 5 GHz AP 141 and 6 Ghz AP 142.

The non-AP MLD 11 that includes 5 GHz STA 11 and 6 GHz STA 12, is shown as having already established a multi-link association with the logical roaming AP MLD 1 through AP MLD 11 (e.g. a current serving 210 AP MLD). There are two links 202-1 and 202-2 between AP MLD 11 and the non-AP MLD 11. The link 202-1 is between the 5 GHz AP 111 and the 5 GHz STA 11. The link 202-2 is between the 6 Ghz AP 112 and the 6 GHz STA 12. Thus, the non-AP MLD 11 can execute data frame exchanges with the current serving 210 AP MLD 11 affiliated with the logical roaming AP MLD 1.

The non-AP MLD 11 in many example embodiments is mobile and can physically move relative to the logical roaming AP MLD 1. Therefore, the non-AP MLD 11 may roam from one AP MLD 11 (i.e. the current serving 210 AP MLD) affiliated with the AP MLD 1 to another AP MLD 12 (i.e. a new serving 212 AP MLD) affiliated with the logical roaming AP MLD 1 without a need for reassociation (i.e. hitless/seamless roaming).

Through the roaming operation 206, the non-AP MLD 11 establishes new setup links 204-1 and 204-2 between the AP MLD 12 and then non-AP MLD 11, and a frame exchange context of the non-AP MLD 11 is transferred from the current serving 210 AP MLD 11 to the new serving 212 AP MLD 12 for future frame exchanges. The new setup link 204-1 is between the 5 GHz AP 121 and the 5 GHz STA 11, and the new link 204-2 is between the 6 Ghz AP 122 and the 6 GHz STA 12.

In some example embodiments a distribution system (DS) 208 connects APs into an ESS (Extended Service Set). An ESS can include any combination of one or more logical roaming AP MLDs, one or more AP MLDs and one or more APs. Thus in some example embodiments more than one logical roaming AP MLDs can exist in a single ESS.

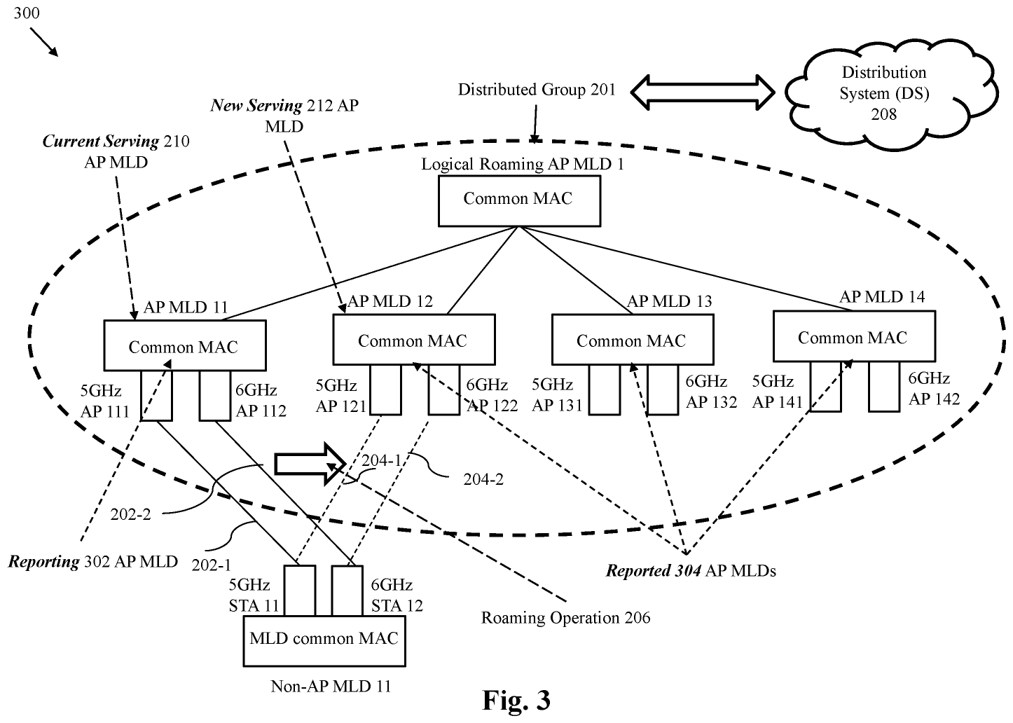

FIG. 3 represents an example 300 of reporting 302 and reported 304 links supporting the roaming operation 206 of the roaming non-AP MLD 11. The reporting link is the link where a management frame is transmitted and the reported link is a link (say link2) whose information is carried in a management frame that is transmitted in a different link (say link1 as the reporting link).

Since the non-AP MLD 11 is currently in communication with the logical roaming AP MLD 1 via AP MLD 11 in the distributed group 201, prior to switching to a new serving AP MLD through the roaming operation 206 of the roaming non-AP MLD, AP MLD 11 is labeled as a reporting 302 AP MLD where one of its affiliated AP will be used to transmit the management frame with the roaming information and the other AP MLDs 12, 13, 14 are labeled as reported 304 AP MLDs where their information will be transmitted by the management frame of the reporting AP MLD.

In various example embodiments, when the non-AP MLD 11 switches (i.e. roams) from one AP MLD (a.k.a. the current serving 210 AP MLD) affiliated with the logical roaming AP MLD 1 to another AP MLD (a.k.a. the new serving 212 AP MLD) affiliated with the same roaming AP MLD 1, a link addresses of the new serving 212 AP MLD is carried in a protected roaming action frame.

When a non-AP MLD roams from one AP MLD (e.g. the current serving 210 AP MLD) affiliated with a logical roaming AP MLD to another AP MLD (e.g. the new serving 212 AP MLD) affiliated with the same logical roaming AP MLD, there is no need for a new association since the non-AP MLD made an association with the logical roaming AP MLD when the non-AP MLD establishes a multi-link connection with an AP MLD affiliated with the logical roaming AP MLD. When a non-AP MLD roams from one AP MLD (e.g. the current serving 210 AP MLD) affiliated with a logical roaming AP MLD to another AP MLD (e.g. the new serving 212 AP MLD) affiliated with the same logical roaming AP MLD, there is no need for a new PMK and PTK since the non-AP MLD made PMK and PTK negotiation with the logical roaming AP MLD when the non-AP MLD establishes a multi-link connection with an AP MLD affiliated with the logical roaming AP MLD.

“Features” in a context of WLAN (wireless local area network) communications are herein broadly defined to include any setup, service, protocol, or hardware configuration that enables a wireless communications system to operate in a manner defined by a standard, preferred by a manufacturer, and/or preferred by an end user.

Currently for AP MLDs, various features (e.g. medium access control (MAC) features) are allocated to either their physical link level or their AP MLD level. For example, currently MAC features allocated to the physical link level are: backoff, (MU)EDCA Parameters, power management mode, power save state. And, currently MAC features allocated to the MLD level are: a listen interval, a maximal idle time, BA agreement, EPCS, SCS, TID to link mapping, AP MLD reconfiguration, and link recommendation.

However, feature allocations in roaming AP MLD applications are currently undefined.

Now discussed are example sets of feature allocations for roaming AP MLD applications. The allocations herein discussed can be at the roaming AP MLD level, the AP MLD level for a set of AP MLDs affiliated with the roaming AP MLD, and/or the link level between various MLD devices. When the non-AP MLD switches to a new serving AP MLD, the features at the roaming AP MLD level for the non-AP MLD either are in a common place (e.g. the distribution of the Data frames to the correct serving AP MLD) or be transferred to the new serving AP MLD as the frame exchange context switch (e.g. the PN, PTK, replay counters, unallocated SN, reorder buffer information, the largest SN whose related frame is sent to the up layer) if the features are not in the common place.

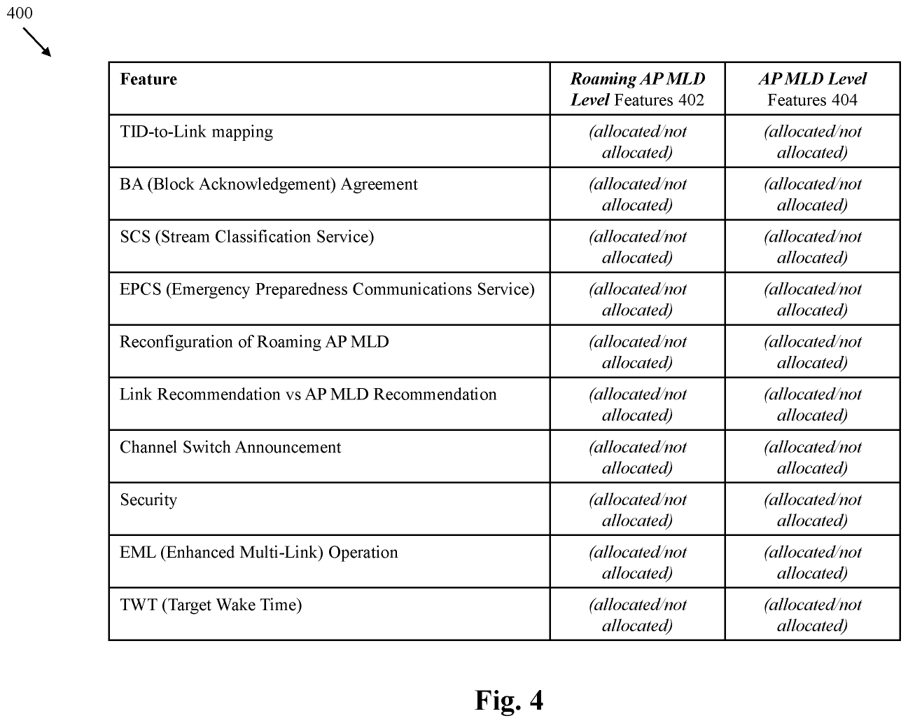

FIG. 4 represents an example protocol 400 for feature allocation. The example protocol 400 can be configured in a variety of example embodiments to allocate one or more roaming AP MLD level features 402, and/or AP MLD level features 404.

Examples embodiments for various wireless communications features are now discussed, however additional feature allocations of current or future features as at least one of roaming AP MLD level features 402, and/or AP MLD level features 404 are possible and herein contemplated, especially as various wireless communications standards and applications improve over time.

### TID-to-Link Mapping

TIDs (Traffic Identifiers) assign a priority level to different types of data traffic (e.g. video, voice, email, or other data). Example feature allocation protocols are as follows.

TID-to-Link mapping negotiation support. In a first example embodiment, all AP MLDs of a roaming AP MLD announce the same TID-to-Link mapping support level (No Support, TID-to-Link mapping negotiation level 1 where all TIDs are mapped to the same set of setup links through the negotiation, TID-to-Link mapping negotiation level 3 where the different TIDs can be mapped to the different setup links through the negotiation). In a second example embodiment, the different AP MLDs of a roaming AP MLD can announce the different TID-to-Link mapping negotiation support levels.

TID-to-link mapping announcement by (roaming) AP MLD. In a first example embodiment, each AP MLD affiliated with a roaming AP MLD can announce its own TID-to-Link mapping (which TID being mapping to which links). In a second example embodiment, the roaming AP MLD can announce its TID-to-Link mapping (which TID being mapping to which links).

TID-to-link mapping negotiation. In a first example embodiment, a non-AP MLD has setup links with multiple AP MLDs affiliated with the roaming AP MLD (e.g. UHR non-AP MLDs), and the roaming AP MLD and the non-AP MLD negotiate the TIDs being mapped to each AP MLDs, or the non-AP MLD negotiates with each AP MLD the TID-to-link mapping for the TIDs being mapped to the AP MLD.

In a second example embodiment, a non-AP MLD has setup links with one AP MLD affiliated with the roaming AP MLD (e.g. EHT non-AP MLDs), and the non-AP MLD negotiates with the AP MLD the TID-to-link mapping. When a non-AP MLD roams from the current serving AP MLD (AP MLD 1) to the new serving AP MLD (AP MLD 2), the negotiated TID-to-link mapping with AP MLD 1 can't be used with AP MLD 2. However the non-AP MLD can negotiate the TID-to-link mapping with the AP MLD 2 during the roaming negotiation.

In a third example embodiment, a non-AP MLD and the roaming AP MLD announce its TID-to-Link mapping.

In a fourth example embodiment, a non-AP MLD and the AP MLD with which the non-AP MLD has setup links announce its TID-to-Link mapping.

In a fifth fourth example embodiment, if a non-AP MLD has setup links with an AP MLD affiliated with the roaming AP MLD, then the non-AP MLD may follow the TID-to-Link mapping announced by the associated AP MLD in addition to the negotiated TID-to-Link mapping.

In a sixth fourth example embodiment, if a non-AP MLD has setup links with multiple AP MLDs affiliated with the roaming AP MLD, then a TID-to-Link mapping that is negotiated using individually addressed frames during the roaming procedure may override the TID-to-Link mapping announced by the AP MLD affiliated with the roaming AP MLD

### BA (Block Acknowledgement) Agreement

In some example embodiments, the BA agreement is a roaming MLD level feature, and the BA negotiation is done between a non-AP MLD and the roaming AP MLD. The BA agreement is kept when the non-AP MLD roam from the current serving AP MLD to the new serving AP MLD. In one embodiment the BA agreement transmit buffer (the WinStartO, WinSoizeO, the frames in the buffer) is transferred to the new serving AP MLD. In another embodiment, the WinStartO, WinSizeO of the transmit buffer are transferred to the new serving AP MLD. In one embodiment the BA agreement reorder buffer (the WinStartB, WinSoizeB, the frames in the reorder buffer) is transferred to the new serving AP MLD. In another embodiment, the largest SN whose related frame is transmitted to the up layer (the WinStartB) and WinSizeB of the reorder buffer are transferred to the new serving AP MLD. In one embodiment, the type of information of BA transmit buffer, reorder buffer being transmitted to the new serving AP MLD is notified to the non-AP MLD. In one embodiment, the non-AP MLD and the new serving AP MLD can do the BA negotiation during the roaming negotiation if the new BA agreement is expected, otherwise the BA agreement is kept after the roaming.

### TWT Agreement

In some example embodiments, the TWT agreement (either individual or broadcast TWT agreement) is a roaming MLD level feature, and the TWT negotiation is done between a non-AP MLD and the roaming AP MLD. The TWT agreement is kept when the non-AP MLD roam from the current serving AP MLD to the new serving AP MLD. In one embodiment the TWT agreement is transferred to the new serving AP MLD. In one embodiment, the kept TWT agreement has TWT start time update while keeping the TWT SP duration and TWT interval. In one embodiment, the non-AP MLD and the new serving AP MLD can do the TWT negotiation during the roaming negotiation if the new TWT agreement is expected, otherwise the TWT agreement is kept after the roaming. In one embodiment the TWT agreement is not transferred to the new serving AP MLD. In one embodiment, the non-AP MLD and the new serving AP MLD can do the TWT negotiation during the roaming negotiation if the TWT agreement is expected to be ready right away after the roaming.

### SCS (Stream Classification Service)

Stream Classification Service (SCS) sets an end-to-end Quality of Service (QoS) treatment for specific IP flows, including at least one of: distribution system communications, network communications, gaming, voice, video, etc.

In a first example embodiment, the SCS agreement is roaming MLD level feature, and either all the AP MLDs affiliated with a roaming AP MLD announces the same capabilities of the SCS support, or the SCS negotiation is done between non-AP MLD and roaming AP MLD. When a non-AP MLD roaming from the AP MLD 1 to AP MLD 2, the SCS agreement with the AP MLD 1 is kept at AP MLD 2 (the SCS information of the non-AP MLD is switched to AP MLD 2) unless the non-AP MLD negotiates the new SCS agreement with the AP MLD 2 during the roaming negotiation.

In a second example embodiment, the SCS agreement is AP MLD level feature, and either all the AP MLDs affiliated with a roaming AP MLD announces the same capabilities of the SCS support, or the SCS negotiation is done between non-AP MLD and its current serving AP MLD. When a non-AP MLD roaming from the AP MLD 1 to AP MLD 2, the SCS agreement with the AP MLD 1 is not kept at AP MLD 2. However the non-AP MLD can negotiate the SCS agreement with the AP MLD 2 during the roaming negotiation in order to use the SCS right after the roaming.

### EPCS (Emergency Preparedness Communications Service) Agreement

EPCS features an on-demand capability that assigns a higher priority for select wireless communications.

In a first example embodiment, the EPCS agreement is roaming AP MLD level feature, and all of the AP MLDs affiliated with a roaming AP MLD announces the same capabilities of the EPCS support, or the EPCS negotiation is done between non-AP MLD and roaming AP MLD. When a non-AP MLD roams from AP MLD 1 to AP MLD 2, the EPCS serve of the non-AP MLD negotiated with AP MLD 1 is kept in AP MLD 2 (the EPCS information of the non-AP MLD is switched to AP MLD 2) unless the non-AP MLD update the SCS agreement during the roaming negotiation.

In a second example embodiment, EPCS agreement is AP MLD level feature, all of the AP MLDs affiliated with a roaming AP MLD announces the same capabilities of the EPCS support, or the EPCS negotiation is done between non-AP MLD and its current serving AP MLD. In order to use the EPCS feature with new serving AP MLD affiliated after the roaming, the EPCS negotiation needs to be done with the new serving AP MLD. When a non-AP MLD roams from AP MLD 1 to AP MLD 2, the EPCS serve of the non-AP MLD negotiated with AP MLD 1 is not kept in AP MLD 2 (the EPCS information of the non-AP MLD is not switched to AP MLD 2). However the non-AP MLD can negotiate the SCS agreement during the roaming negotiation in order to use the EPCS right after the roaming.

### Reconfiguration of Roaming AP MLD

In a first example embodiment, adding or removing of a link of an AP MLD affiliated with a roaming AP MLD is announced by the other links of the same AP MLD affiliated with the roaming AP MLD. After the link adding or link removing of an AP MLD (AP MLD 1) affiliated with a roaming AP MLD is done, the neighbor AP MLD affiliated with the roaming AP MLD can announce the links of AP MLD 1.

In a second example embodiment, link adding or link removing of an AP MLD affiliated with a roaming AP MLD will be announced by another AP MLD affiliated with the roaming AP MLD when two AP MLD are neighboring AP MLDs. With this option, the link adding/removing is the roaming AP MLD level feature. Such announcement will happen before the link removing is done.

In a third example embodiment, adding or removing of an AP MLD affiliated with a roaming AP MLD is announced as a reconfiguration at the roaming AP MLD level. This is the critical update of roaming AP MLD. In some example embodiments, the reconfiguration of roaming AP MLD level is not the critical update of roaming AP MLD.

In a fourth example embodiment, AP MLD level addition/removal is also possible. The roaming AP MLD may add/remove one or more affiliated AP MLDs to/from the roaming AP MLD. Each added/removed affiliated AP MLD may be announced through a Basic Multi-Link element, a Reduced Neighbor Report element, a Reconfiguration Multi-Link element, and/or a new element in the Beacon frame and Probe Response frames.

In a fifth example embodiment, when removing an affiliated AP MLD, all the APs affiliated with the AP MLD are removed from the roaming AP MLD (e.g., removed AP and AP MLD will not support smooth roaming within the roaming AP MLD after removal from the roaming AP MLD regardless of the actual AP MLD operation).

In a sixth example embodiment, temporary removal of affiliated AP MLD from the roaming AP MLD can be done through the timer information inclusion in the element, which the affiliated AP MLD is not available for smooth roaming during the time period.

### Link Recommendation vs AP MLD Recommendation

In a first example embodiment, link recommendation is AP MLD level feature. and, an AP MLD announces the link recommendation within the links of the AP MLD.

In a second example embodiment, link recommendation is roaming AP MLD level feature, and the roaming AP MLD announces the link recommendation of the current serving AP MLD and the link recommendation of the another (new) serving AP MLD.

In a second example embodiment, for AP MLD recommendation, the roaming AP MLD recommends an AP MLD affiliated with the roaming AP MLD as a serving AP MLD for one or more of non-AP MLDs. Such recommendation can be done through the BSS Transition Request/Response frame or the new defined Action frames. The frame indicates whether the transition is within the roaming MLD or not.

### Channel Switch Announcement

In a first example embodiment, if one AP (say AP1) of an AP MLD (say AP MLD 1) affiliated with a roaming AP MLD announces its channel switch before AP1's real channel switch, the other APs affiliated with the same AP MLD as AP1 will announce AP1's channel switch also before AP1's real channel switch. And the AP MLDs affiliated with the same roaming AP MLD as AP MLD 1 will not announce AP′1's channel switch before AP1's real channel switch.

In a second example embodiment, if one AP (say AP1) of an AP MLD (say AP MLD 1) affiliated with a roaming AP MLD announces its channel switch before AP1's real channel switch, the other APs affiliated with the same AP MLD as AP1 will announce AP1's channel switch also before AP1's real channel switch. And the AP MLDs affiliated with the same roaming AP MLD as AP MLD 1 will announce AP′1's channel switch before AP1's real channel switch.

### Security

In some example embodiments, security is a roaming AP MLD level feature. The authenticator address in PMKSA, PTKSA is the MAC SAP address of the roaming AP MLD. The Key Data in a EAPOL-Key frame carries the MAC SAP address of the roaming AP MLD as the authenticator address if the EAPOL-Key frame carries the authenticator address. The PTK is calculated by including the MAC SAP address of the roaming AP MLD. After a non-AP MLD roams from AP MLD 1 to AP MLD 2, the PTK related information (PN, PTK, replay counters) in AP MLD 1 for the non-AP MLD are transferred to the AP MLD 2.

### EML (Enhanced Multi-Link) Operation

In a first example embodiment, EMLSR(Single Radio) operation is AP MLD level feature. A non-AP MLD negotiates the EMLSR or EMLMR (Multi-Radio) mode with its serving AP MLD. After the smooth roaming, the EMLSR/EMLMR mode is not kept.

In a second example embodiment, EMLSR operation is roaming AP MLD level feature. A non-AP MLD negotiates the EMLSR/EMLMR mode with the roaming AP MLD. After the smooth roaming, the EMLSR/EMLMR mode is kept.

Various example sets of instructions for implementing the protocol 400 for wireless communication feature allocation can be based on various applications of the material discussed in this specification. An order in which the material discussed in this specification has been discussed does not limit an ordering of such instructions unless otherwise specifically stated. Additionally, in some example embodiments the instructions could be implemented in parallel.

Various systems, such as the example second example WLAN 200 just discussed, can host these instructions. Such systems can include an input/output data interface, a processor, a storage device, and a non-transitory machine-readable storage medium. The machine-readable storage medium includes the instructions which control how the processor receives input data and transforms the input data into output data, using data within the storage device. The machine-readable storage medium in an alternate example embodiment is a non-transitory computer-readable storage medium. In other example embodiments the set of instructions described above can be implemented either using logic gates, application specific chips, firmware, as well as other hardware forms.

In some example embodiments the set of instructions described above are implemented as functional and software instructions. In other embodiments, the instructions can be implemented either using logic gates, application specific chips, firmware, as well as other hardware forms.

When the instructions are embodied as a set of executable instructions in a non-transitory computer-readable or computer-usable media which are effected on a computer or machine programmed with and controlled by said executable instructions. Said instructions are loaded for execution on a processor (such as one or more CPUs). Said processor includes microprocessors, microcontrollers, processor modules or subsystems (including one or more microprocessors or microcontrollers), or other control or computing devices. A processor can refer to a single component or to plural components. Said computer-readable or computer-usable storage medium or media is (are) considered to be part of an article (or article of manufacture). An article or article of manufacture can refer to any manufactured single component or multiple components. The non-transitory machine or computer-usable media or mediums as defined herein excludes signals, but such media or mediums may be capable of receiving and processing information from signals and/or other transitory mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

It will be readily understood that the components of the embodiments as generally described herein and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may but do not necessarily, all refer to the same embodiment.

What is claimed is:

1. A protocol for wireless communication feature allocation, comprising:
wherein the protocol is configured to,
allocate a first set of features to a roaming AP (access point) MLD (multi-link device); and
allocate a second set of features to a set of AP MLDs affiliated with the roaming AP MLD.

2. The protocol of claim 1:
wherein the set of features includes Traffic Identifier (TID) to Link mapping.

3. The protocol of claim 2:
wherein all of the set of AP MLDs of the roaming AP MLD announces a same TID-to-Link mapping negotiation support level.

4. The protocol of claim 2:
wherein at least one of the set of AP MLDs of the roaming AP MLD announce a different TID-to-Link mapping negotiation support level.

5. The protocol of claim 2:
wherein the roaming AP MLD announces a TID-to-Link mapping.

6. The protocol of claim 2:
wherein a non-AP MLD has multiple sets of setup links with the set of AP MLDs.

7. The protocol of claim 6:
wherein the roaming AP MLD and the non-AP MLD negotiate which TID is mapped to each of the set of AP MLDs.

8. The protocol of claim 6:
wherein the non-AP MLD negotiates with each of the set of AP MLDs which TID is mapped to each of the set of AP MLDs.

9. The protocol of claim 6:
wherein TID-to-Link mapping that is negotiated using individually addressed frames during a roaming procedure may override TID-to-Link mapping announced by at least one of the set of AP MLDs affiliated with the roaming AP MLD.

10. The protocol of claim 2:
wherein a non-AP MLD has one set of setup links with one of the set of AP MLDs.

11. The protocol of claim 10:
wherein the non-AP MLD negotiates with the one of the set of AP MLDs the TID-to-link mapping.

12. The protocol of claim 10:
wherein the non-AP MLD may follow a TID-to-Link mapping announced by an associated AP MLD in addition to a negotiated TID-to-Link mapping.

13. The protocol of claim 1:
wherein the set of features includes a Block Acknowledgement (BA) agreement, the BA agreement is a roaming MLD level feature, and the BA negotiation is done between a non-AP MLD and the roaming AP MLD.

14. The protocol of claim 1:
wherein the set of AP MLDs all announce a same feature agreement.

15. The protocol of claim 1:
wherein a feature agreement negotiation is done between a non-AP MLD and the roaming AP MLD.

16. The protocol of claim 1:
wherein a feature agreement negotiation is done between a non-AP MLD and a current serving AP MLD.

17. The protocol of claim 1:
wherein a feature agreement negotiation is done between a non-AP MLD and a new serving AP MLD.

18. The protocol of claim 1:
wherein the set of features includes at least one of: a stream classification service (SCS), Emergency Preparedness Communications Service (EPCS) agreement, link recommendation, and EML (Enhanced Multi-Link) Operation; and
wherein the at least one of the set of features is a roaming AP MLD level feature.

19. The protocol of claim 1:
wherein the set of features includes at least one of: a stream classification service (SCS), Emergency Preparedness Communications Service (EPCS) agreement, link recommendation, AP MLD recommendation, security, and EML (Enhanced Multi-Link) Operation; and
wherein the at least one of the set of features is an AP MLD level feature.

20. The protocol of claim 1:
wherein the set of features includes a channel switch announcement; and
wherein a first one of the set of AP MLDs announces a channel switch before completing the channel switch, and another one of the set of AP MLDs announces the first one of the set of AP MLDs channel switch also before the channel switch is completed.

21. The protocol of claim 1:
wherein adding or removing of a link of at least one of the set of AP MLDs is announced by other links of the at least one of the set of AP MLDs.

22. The protocol of claim 1:
wherein adding or removing of a link of at least one of the set of AP MLDs is announced by another one of the set of AP MLDs when the at least one and the another one of the set of AP MLDs are neighboring AP MLDs.

23. The protocol of claim 1:
wherein adding or removing of a link of at least one of the set of AP MLDs is announced as a reconfiguration at the roaming AP MLD level.

24. The protocol of claim 1:
wherein at least one of the set of AP MLDs are configured to allocate at least one of the second set of features to a physical link level of the at least one AP MLD with a non-AP device.

25. The protocol of claim 1:
wherein the features include medium access control (MAC) features;
wherein the roaming AP MLD has a MAC service access point (SAP) address; and
wherein the first AP MLD and the second AP MLD have a same MAC SAP address as the roaming AP MLD.

26. The protocol of claim 1:
wherein the set of AP MLDs includes a first AP MLD and a second AP MLD;
wherein a first set of links are established between a non-AP MLD and the first AP MLD when the non-AP MLD is at a first physical location; and
wherein a second set of links are established between the non-AP MLD and the second AP MLD when the non-AP MLD is at a second physical location.

27. The protocol of claim 26:
wherein the non-AP MLD is either a UHR non-AP MLD or an EHT non-AP MLD.

28. The protocol of claim 1:
wherein the set of features includes Target Wake Time (TWT).

29. A method for feature allocation between a roaming AP MLD and a set of affiliated AP MLDs for wireless communications, comprising:
allocating a first set of features to a roaming AP (access point) MLD (multi-link device); and
allocating a second set of features to a set of AP MLDs affiliated with the roaming AP MLD.
